(19) United States
(12) Patent Application Publication
(10) Pub. No.: US 2011/0041558 A1
(43) Pub. Date: Feb. 24, 2011

(54) HEAT TREATMENT APPARATUS FOR TEMPERING GLASS

(76) Inventor: Han Gon KIM, Daegu-City (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/855,172

(22) Filed: Aug. 12, 2010

(30) Foreign Application Priority Data
Aug. 19, 2009 (KR) 10-2009-0076692
Dec. 17, 2009 (KR) 10-2009-0126163

(51) Int. Cl. C03B 29/06

(52) U.S. Cl. 65/181

(57) ABSTRACT

Provided is a heat treatment apparatus for tempering glass capable of stabilizing quality and increasing productivity by inducing a stability and smoothness between processes during automatically performing of a heat treatment operation for the tempered surface of thin plate type glass, and including a preheating furnace, a main body furnace, and a cooling furnace, the apparatus including: a traveling unit for moving a conveying bogie on a pair of rails installed in parallel on the preheating furnace, the main body furnace, and the cooling furnace; a rack elevating unit for stably performing an up and down motion of a rack in which the thin plate type glass included in the conveying bogie is accommodated; and a muffle disposed on the main body furnace and performing an indirect heating operation.

### CROSS-REFERENCE TO RELATED PATENT APPLICATION

This application claims the benefit of Korean Patent Application Nos. 10-2009-0126163, filed on Dec. 17, 2009, and 10-2009-0076692, filed on Aug. 19, 2009, in the Korean Intellectual Property Office, the disclosure of which is incorporated herein in its entirety by reference.

### BACKGROUND OF THE INVENTION

1. Field of the Invention

The present invention relates to a heat treatment apparatus for tempering glass, and more particularly, to a heat treatment apparatus for tempering glass capable of stabilizing quality and increasing productivity by inducing a stability and smoothness between processes during automatically performing of a heat treatment operation for the tempered surface of thin plate type glass.

2. Description of the Related Art

In general, tempered glass used for a mobile phone, a PC, a PDA, a navigation system, glasses for construction and various industries, and the like is a thin plate type glass having the characteristics of a low occurrence of scratches and excellent permeability. However, it is necessary to perform a heat treatment operation for tempering the surface of the tempered glass so as to maintain the characteristics thereof, and thus mass production quality and productivity based on automation facilities are required.

For example, Korean U.M. Registration No. 0432508 discloses an apparatus for manufacturing tempered glass having a predetermined thickness and permeability for a display window by sequentially going through a preheating furnace, a salt furnace, an annealing furnace, a hot water furnace, a heating water furnace, and a drying furnace by using a conveying unit, and automatically carrying an entire structure by using a moving unit.

However, the conventional apparatus shakes during conveyance due to a thermally expanding peripheral portion thereof caused by heat of high temperature tempered glass while going through the preheating furnace and the salt furnace, which delaying the conveyance thereof, and thus a heat treatment temperature varies exceeding a set range, which further adversely influencing quality thereof.

### SUMMARY OF THE INVENTION

The present invention provides a heat treatment apparatus for tempering glass capable of stabilizing quality and increasing productivity by inducing a stability and smoothness between processes during automatically performing of a heat treatment operation for the tempered surface of thin plate type glass.

According to an aspect of the present invention, there is provided a heat treatment apparatus for tempering thin plate type glass and including a preheating furnace, a main body furnace, and a cooling furnace, the apparatus including: a traveling unit for moving a conveying bogie on a pair of rails installed in parallel on the preheating furnace, the main body furnace, and the cooling furnace; a rack elevating unit for stably performing an up and down motion of a rack in which the thin plate type glass included in the conveying bogie is accommodated; and a muffle disposed on the main body furnace and performing an indirect heating operation.

### BRIEF DESCRIPTION OF THE DRAWINGS

The above and other features and advantages of the present invention will become more apparent by describing in detail exemplary embodiments thereof with reference to the attached drawings in which:

FIG. 1 is a general schematic diagram of a heat treatment apparatus for tempering glass according to an embodiment of the present invention;

FIGS. 2A and 2B are schematic diagrams of a conveying bogie according to an embodiment of the present invention;

FIGS. 3A through 5C are trigonometric schematic diagrams of the conveying bogie of FIGS. 2A and 2B according to other embodiments of the present invention;

FIGS. 6A through 6C are schematic diagrams of a rack that moves up and down according to an embodiment of the present invention;

FIGS. 7A and 7B are cross-sectional and plan views of a preheating furnace according to an embodiment of the present invention;

FIGS. 8A and 8B are cross-sectional and plan views of a main body furnace according to an embodiment of the present invention;

FIGS. 9A and 9B are cross-sectional and plan views of an annealing furnace according to an embodiment of the present invention;

FIGS. 10A and 10B are cross-sectional and plan views of a hot water furnace according to an embodiment of the present invention;

FIGS. 11A and 11B are cross-sectional and plan views of a cool water furnace according to an embodiment of the present invention;

FIG. 12 is a side schematic diagram of a heat treatment apparatus for tempering glass according to an embodiment of the present invention;

FIGS. 13A through 13C are plan, front, and side views of a conveying bogie according to an embodiment of the present invention;

FIGS. 14A through 16 are schematic diagrams of a traveling unit and a moving unit of a heat treatment apparatus for tempering glass according to an embodiment of the present invention;

FIGS. 17A and 18 are schematic diagrams of the heat treatment apparatus for tempering glass of FIGS. 15A and 15B according to other embodiments of the present invention; and

FIGS. 19A through 19J are schematic diagrams of a muffle according to other embodiments of the present invention.

### DETAILED DESCRIPTION OF THE INVENTION

Hereinafter, the present invention will be described in detail by explaining exemplary embodiments of the invention with reference to the attached drawings.

The present invention relates to a heat treatment apparatus for tempering thin plate type glass sequentially including a preheating furnace 10, a main body furnace 20, and a cooling furnace 30.

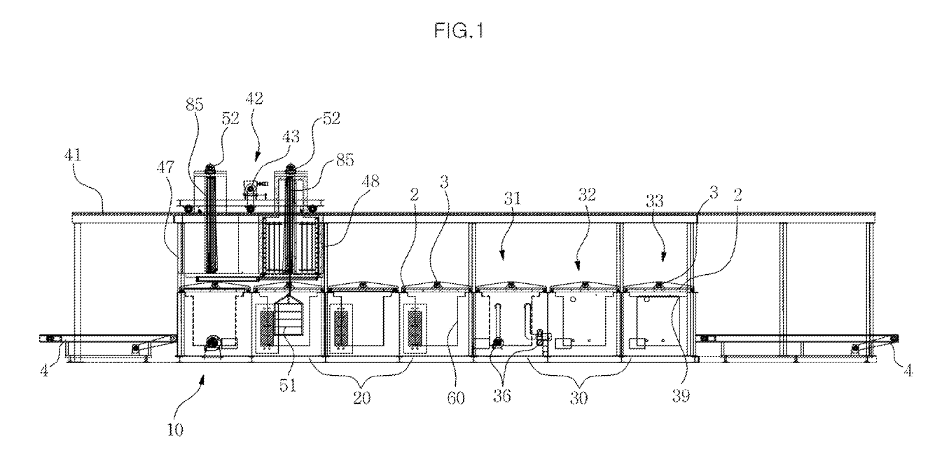

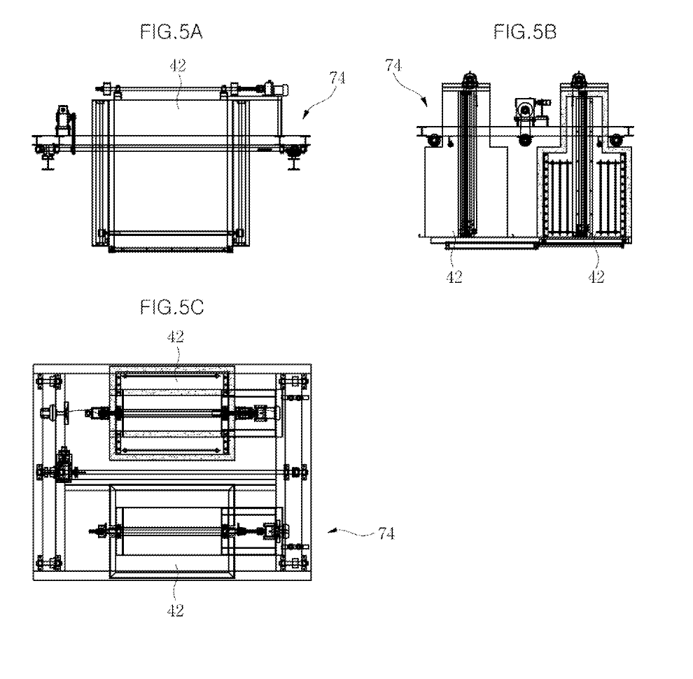

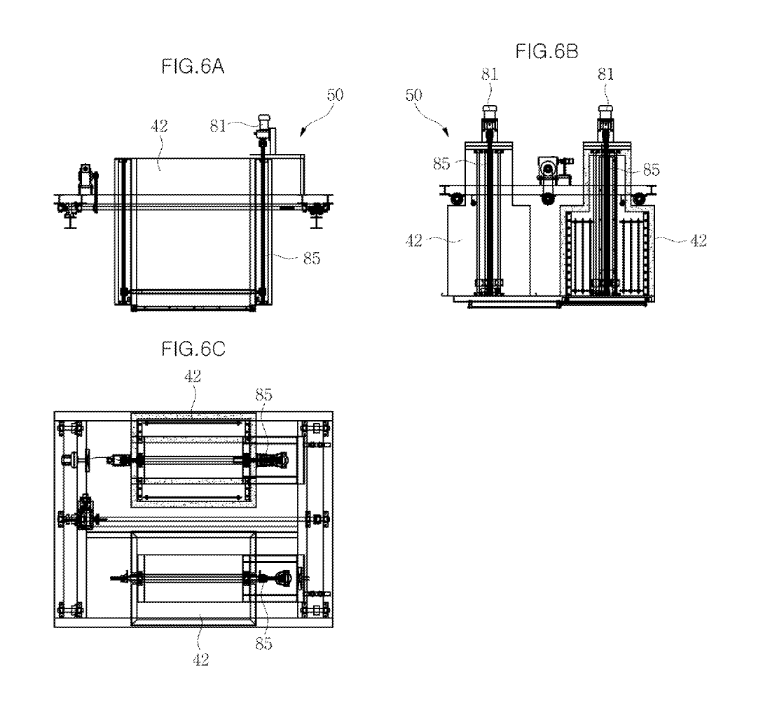

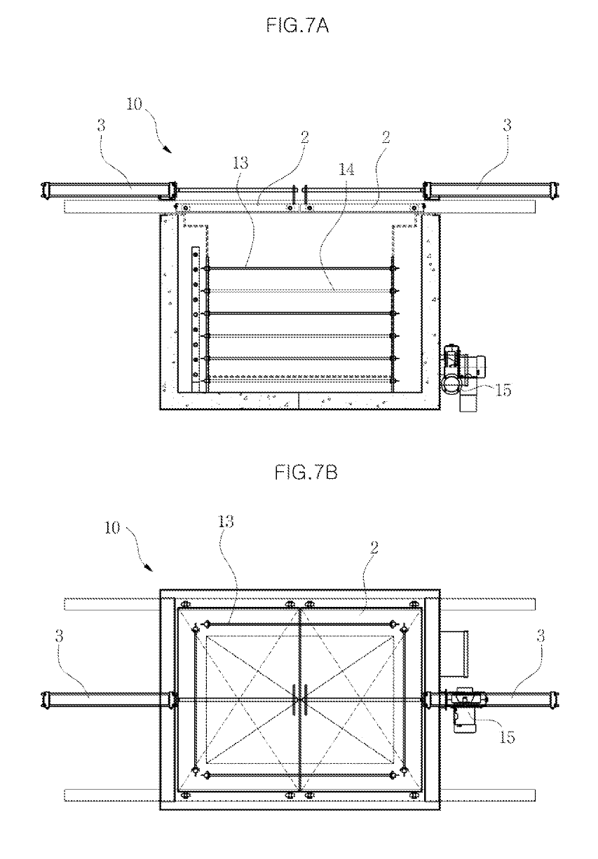

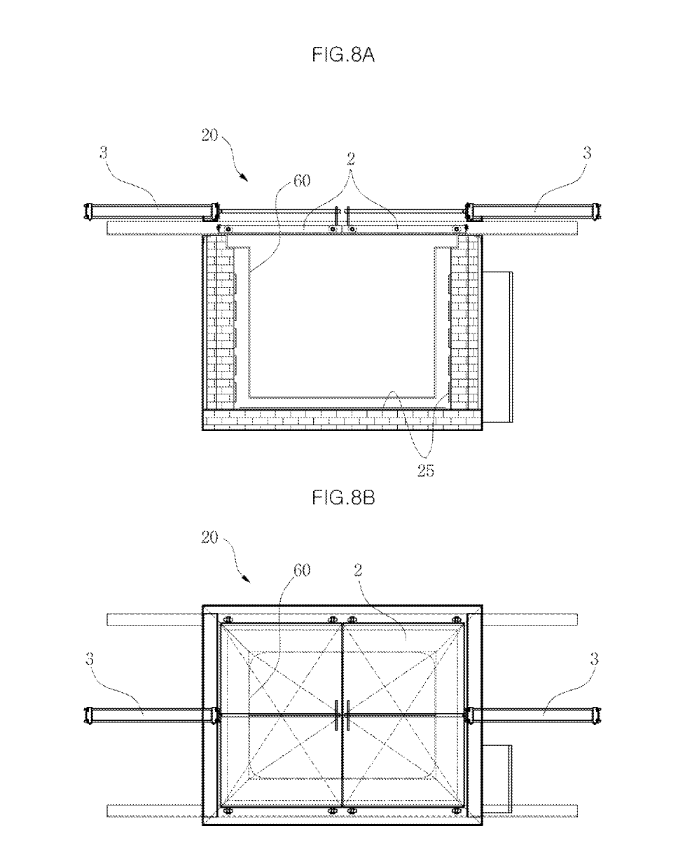

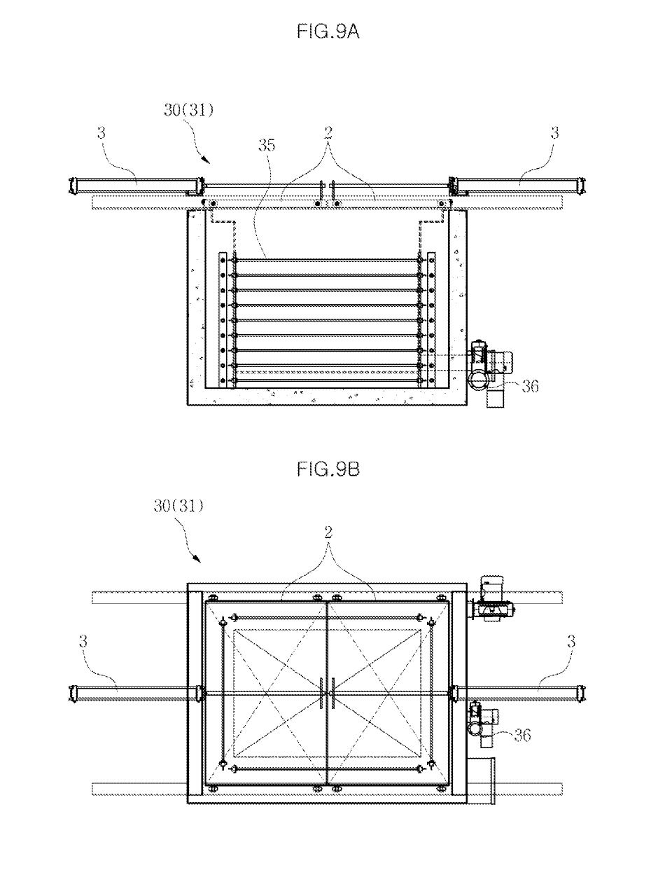

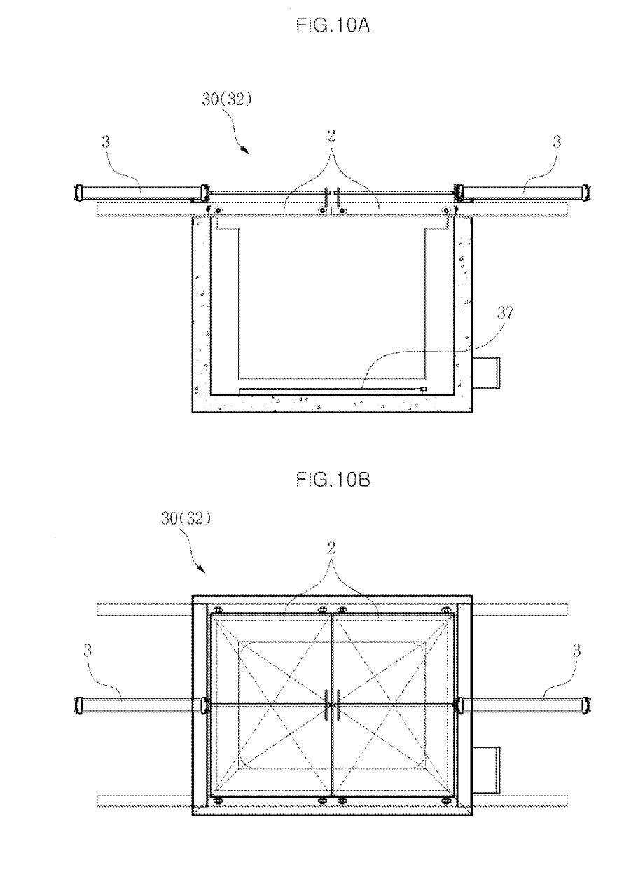

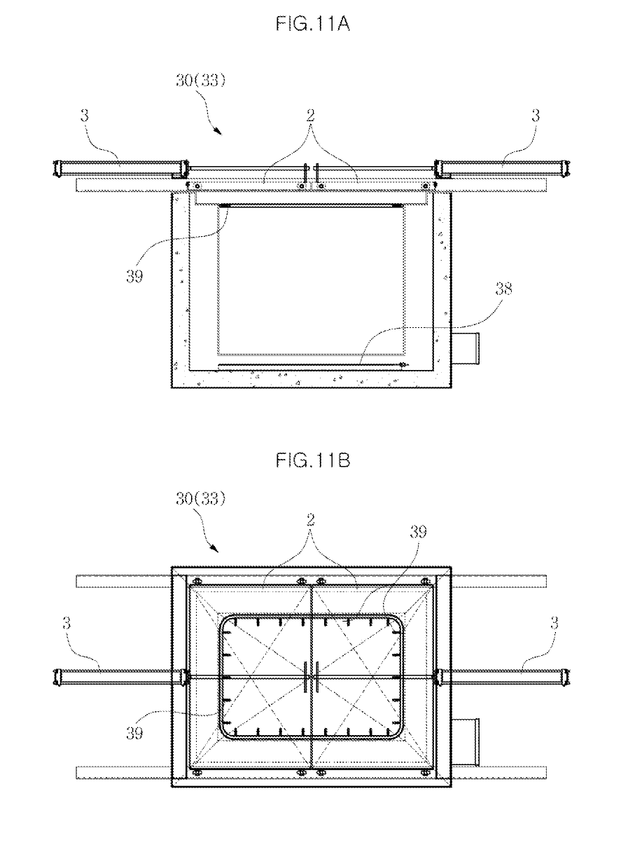

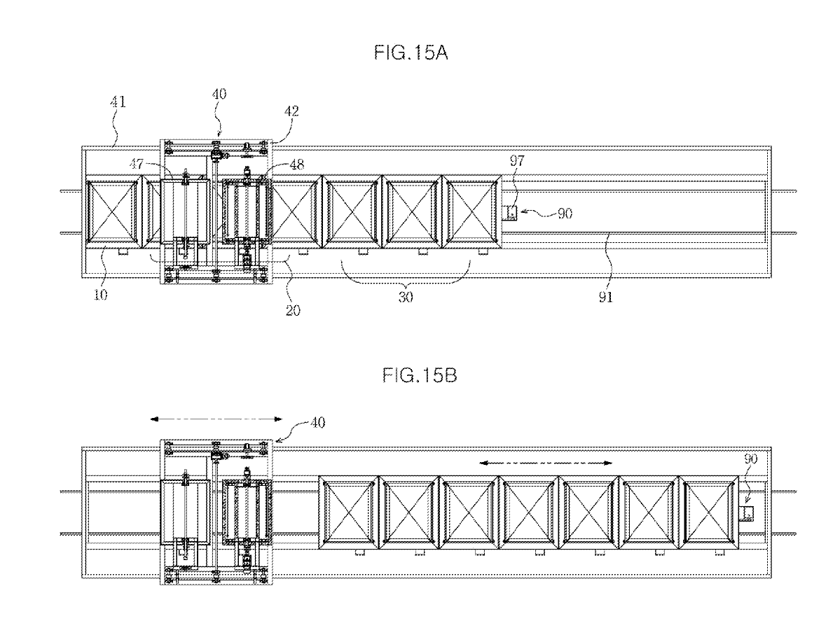

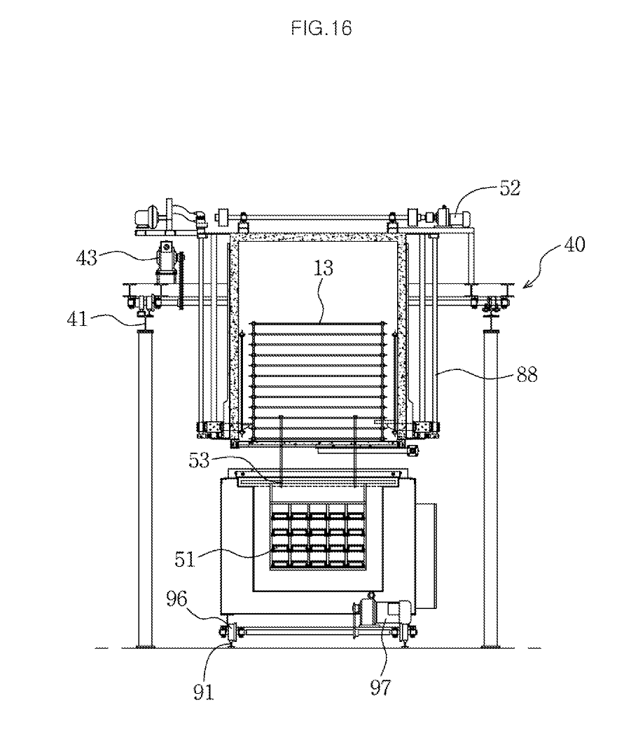

Referring to FIGS. 1 through 19J, the heat treatment apparatus for tempering the thin plate type glass sequentially including the preheating furnace 10, the main body furnace 20, and the cooling furnace 30 of the present invention includes a traveling unit 40 installed in parallel on the preheating furnace 10, the main body furnace 20, and the cooling furnace 30, a rack elevating unit 50 for performing an up and down motion of a rack 51, and a muffle 60 disposed on the main body furnace 20.

The tempered thin plate type glass is loaded on the rack 51 that will be described, is conveyed to a conveyer 4, is thermally treated, and is conveyed to a subsequent process through the conveyer 4.

The structures of the preheating furnace 10, the main body furnace 20, and the cooling furnace 30 are as follows.

According to the present invention, the preheating furnace 10 having a structure of a heat insulation wall and capable of being upward opened and closed performs ventilation and heating functions. The preheating furnace 10 has a box type structure having an open upper portion in which a door 2 and a cylinder 3 are installed. The preheating furnace 10 alternately includes a pipe heater 13 and a far infrared ray heater 14 and adjusts a temperature by using a ventilator. The preheating furnace 10 performs a heat treatment operation for 1 hour at a temperature of 400° C. and is preferable for maintaining a constant temperature by alternately positioning the pipe heater 13 and the far infrared ray heater 14 therein. For a fine control, a temperature sensor (not shown) is installed in the preheating furnace 10. If a temperature exceeds a set value, an amount of ventilation of the ventilator 15 increases, and, if the temperature is below the set value, the amount of ventilation of the ventilator 15 decreases.

According to the present invention, the preheating furnace 10 having a structure of a plurality of fire resistant walls and capable of being upward opened and closed is installed to perform an indirect heating operation in at least one side thereof. The main body 20 may be three-layered as shown in FIG. 1 but the present invention is not limited thereto. The main body 20 is heated up to a temperature of 700° C., reinforces potassium nitrate (KNO₃) ions, and is indirectly heated four about 4 hours at a temperature of about 450° C. so as to melt the potassium nitrate (KNO₃).

In this regard, the main body furnace 20 includes a strip heater 25 disposed in the lower side of the muffle 60 in the shape of a container installed to indirectly heat the main body furnace 20. It may be proper to install the strip heater 225 in the lower surface of the main body furnace 20 having a layered structure using fire resistant bricks. The muffle 60 formed of a stainless steel material is installed in the main body furnace 20 to indirectly heat the main body furnace 20. The door 2 and the cylinder 3 are included in the upper portion of the main body furnace 20, and thus the main body furnace 20 can be opened and closed.

The cooling furnace 30 having a structure of a plurality of heat insulation walls and capable of being upward opened and closed is installed to perform a ventilation function and maintain cooling. The cooling furnace 30 includes an annealing furnace 31, a hot water furnace 32, and a cool water furnace 33, which all have a box type structure with open upper portions and include the door 2 and the cylinder 3 in the upper portions. The annealing furnace 31 included in the cooling furnace 30 of the present invention includes a plurality of ventilators 36 and the hot water furnace 32 and the cool water furnace 33 therein include heat plate heaters 37 and 38, respectively. The annealing furnace 31 includes a general pipeline 35, whereas the ventilators 36 may be sufficiently (in plural) installed compared to the other processes. The heat plate heaters 37 and 38 are installed in the hot water furnace 32 and the cool water furnace 33, respectively, and are properly used to maintain a fixed temperature although the fixed temperature is comparatively lower than that of the other processes. A nozzle 33 is included in the cool water furnace 33, and cleans potassium nitrate (KNO₃) remaining on the surface of a product.

According to the present invention, the traveling unit 40 is installed on the preheating furnace 10, the main body furnace 20, and the cooling furnace 30 to move a conveying bogie 42. The conveying bogie 42 is installed to be adjacent to a first chamber 47 including no heater and a second chamber 48 including a heater and is interlocked with the first chamber 47 and the second chamber 48.

The traveling unit 40 integrally includes a pair of rails 41 installed in parallel on the preheating furnace 10, the main body furnace 20, and the cooling furnace 30, and the first chamber 47 including no heater and the second chamber 48 including the heater that can be downward opened and closed, and the conveying bogie 42 installed to travel on the rails 41 with a pair of support rollers 44 and a plurality of travelling wheels 45 disposed therebetween.

A rack 87 is installed in at least one side of the rails 41. The pair of rails 41 is spaced apart from each other by a predetermined gap on the upper sides of the preheating furnace 10, the main body furnace 20, and the cooling furnace 30, whereas the rack 87 may be included in one side of the rails 41.

The conveying bogie 42 is a box type bogie with an open lower surface, includes the door 2 and the cylinder 3 in the lower surface thereof, moves on the rails 41, and performs a function of loading/unloading the product. The first chamber 47 and the second chamber 48 of the conveying bogie 42 in general integrally move and may individually move. The second chamber 48 is formed of a proper fire resistant material and performs a preheating function. The general pipe heater 35 is used as the heater 46.

The pair of support rollers 44 are adjacent to the side surface of one side of the rails 41 and support the rails 41 to minimize shaking. The plurality of traveling wheels 45 are adjacent to the upper surface of another side of the rails 41 and travel on the rails 41. The rack 87 is installed adjacent to the traveling wheels 45. A traveling motor 43 delivers a rotational force to an electric gear 86 with a double chain 83 interposed therebetween. A rotation of the electric gear 86 engaged with the rack 87 realizes a traveling of the conveying bogie 42. The electric gear 86 means a pinion gear engaged with the rack 87. That is, the traveling motor 43 travels by a rotational force applied to the electric gear 86 via the chain 83 and a rotational force applied to the rack 887 engaged with the electric gear 86, and simultaneously by the support rollers 44 and the traveling wheels 45 that rotate on the one side of the rails 41 and another side of the rails 41, respectively.

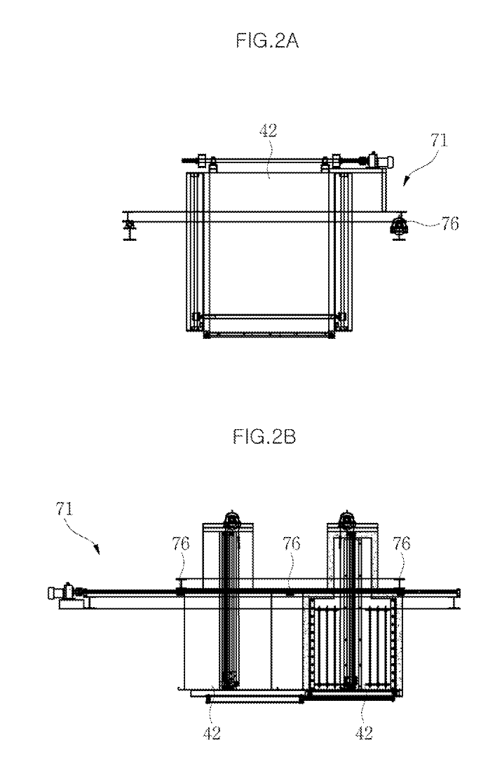

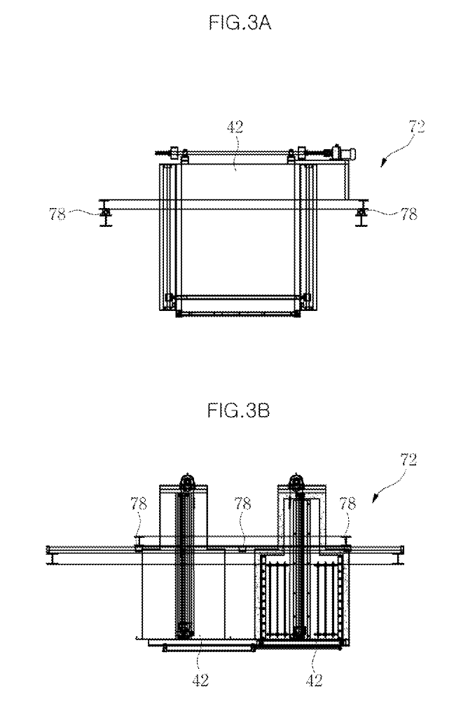

In this regard, the traveling unit 40 of the present invention includes one or more selected from a group consisting of a ball screw driver 71, an LM guide driver 72, a hydraulic and pneumatic driver 73, a square steel driver 74, and a chain driver. Referring to FIGS. 2A and 2B, the ball screw driver 71 is shown, and referring to FIGS. 3A through 5C, modifications of the ball screw driver 71 are shown. The ball screw driver 71 supports the conveying bogie 42 by using spiral shafts in both sides thereof and connects a nut 76 to the conveying bogie 42. Thus, if a motor rotates the spiral shafts, the nut 76 and the conveying bogie 42 perform a rectilinear motion together.

The LM guide driver 72 is similar to the ball screw driver 71 in using a guide rail and spiral shafts, and induces a back and forth motion of the conveying bogie 42 while a block 78 moves forward and backward by a rotation of the motor. The LM guide driver 72 includes a plurality of LM guides 88 having a hallow structure and performing a cooling function. Cooling water is supplied from a cooling water pump 85 and a rotary joint 84 to the LM guides 88. The LM guides 88 are installed in the side surface of the conveying bogie 42 to guide an up and down motion. The LM guides 88 of the present invention have a hallow structure and are connected to the cooling water pump 85 with the rotary joint 84 interposed therebetween. A guide 89 is installed on the LM guides 88 and stably supports the rack 51. Cooling water circulates in the LM guides 88 and thus a thermal expansion is relaxed and a smooth operation is secured during an operation of the guide 89.

The conveying bogie 42 is furnished in an additional rail 98 so that the hydraulic and pneumatic driver 73 connects the conveying bogie 42 to a piston rod of an operating cylinder 79. The operating cylinder 79 means a hydraulic cylinder 3 or a pneumatic cylinder 3 and is selected based on the total weight of the conveying bogie 42.

The traveling wheels 45 of the conveying bogie 42 stably arrive at the rail 98 in a C-shaped cross section so that the square steel driver 74 performs a rectilinear motion while winding or unwinding a wire 56 in the front and rear thereof.

Although not shown, the conveying bogie 42 is installed on a horizontally formed guide rail and the chain 83 rotates so that the chain driver induces a rectilinear motion of the conveying bogie 42.

Further, according to the present invention, the rack elevating unit 50 that allows the rack 51 in which the thin plate type glass is accommodated in the conveying bogie 42 to be conveyed up and down to a hook 53 stably performs the up and down motion of the rack 51. The rack 51 in which a plurality of glass sample products are loaded. The hook 53 performs fastening and unfastening functions in the upper end of the rack 51. The rack elevating unit 50 performs a function of coming and going the rack 51 in and to the preheating furnace 10, the main body furnace 20, and the cooling furnace 30 according to the order of processes.

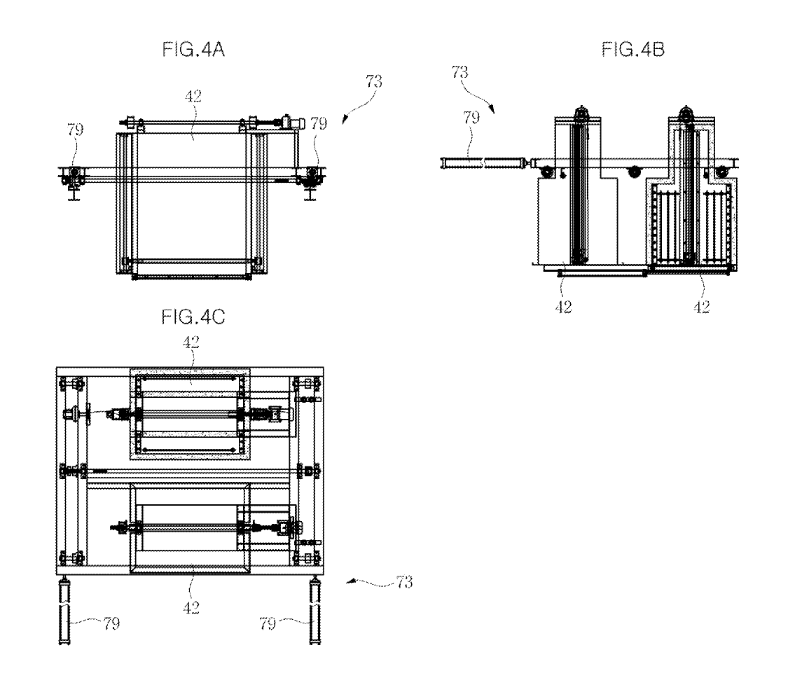

In this regard, the rack elevating unit 50 includes one or more selected from a group consisting of a ball screw driver 81, an LM guide driver, a hydraulic and pneumatic driver, and a chain driver. As a representative example, the ball screw driver 81, like the ball screw driver 71 of FIGS. 2A and 2B, is connected to the rack 51 by vertically installing a spiral shaft and disposing the nut 76 therebetween on the spiral shaft. The LM guide driver and the hydraulic and pneumatic driver are installed and operate in the same manner as described with reference to FIGS. 3A through 4C. The rack 51 is installed on a horizontally formed guide rail and the chain 83 rotates so that the chain driver induces an elevation and falling motion of the rack 51.

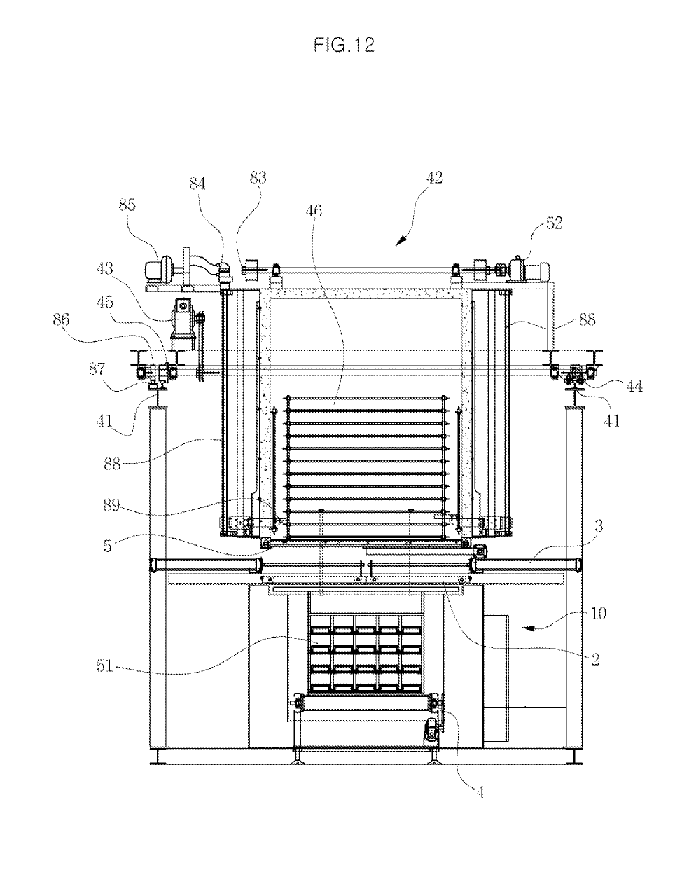

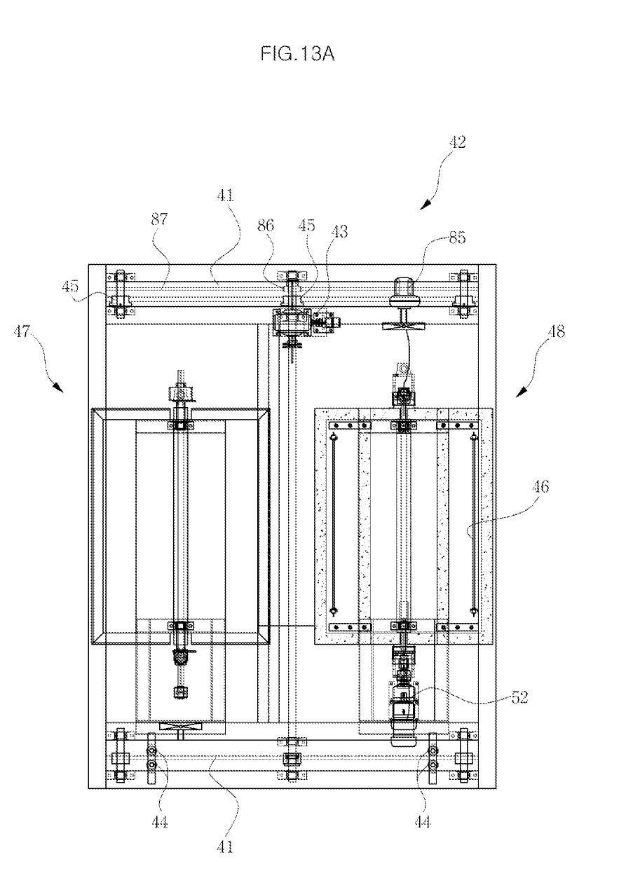

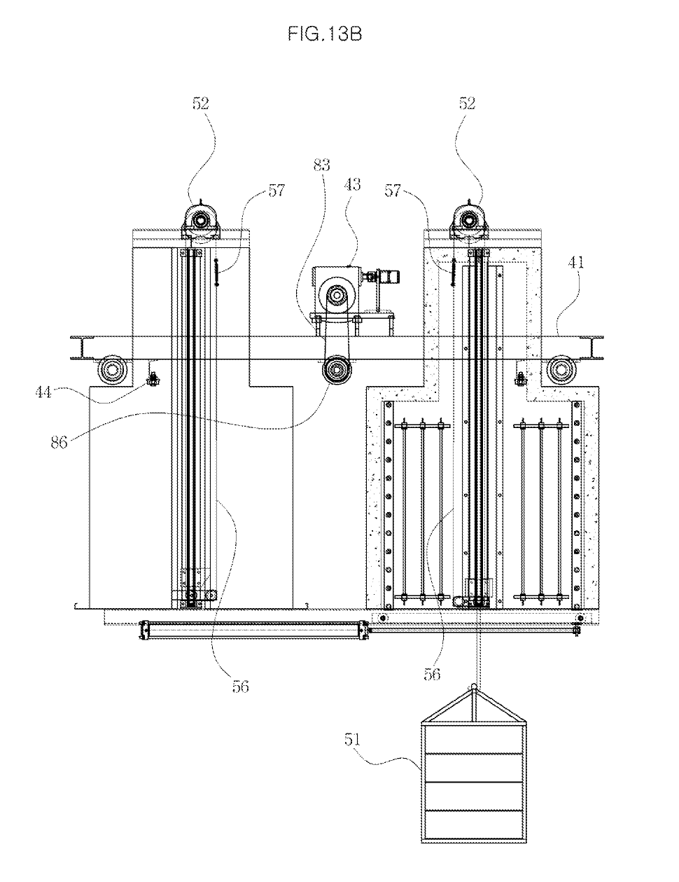

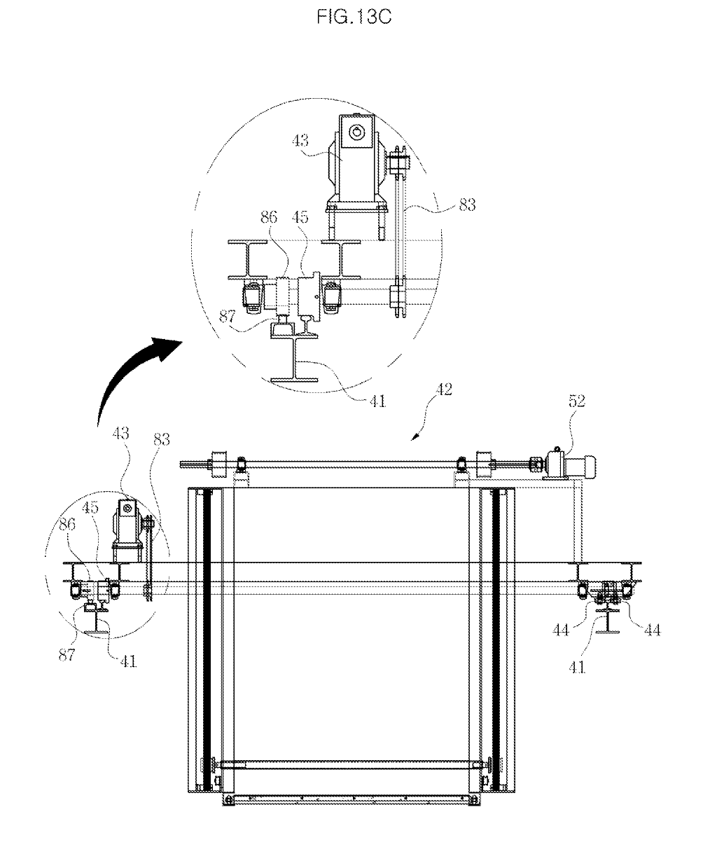

As illustrated in FIGS. 12 and 13C, the rack 51 of the conveying bogie 42 can be connected to an elevating motor 52 by using the wire 56 and move up and down. When the wire 56 supports the load of the rack 51, and a shock absorbing spring 57 is disposed in the middle of the wire 56 and rack 51, and thus a vibration occurring during the conveyance is minimized. The wire 56 may be installed independently or in combination with one or more selected from a group consisting of the ball screw driver 81, the LM guide driver, the hydraulic and pneumatic driver, and the chain driver.

Further, according to the present invention, the muffle 60 for performing an indirect heating operation is disposed on the main body furnace 20. Although the muffle 60 has a bad heating efficiency, since the muffle 60 performing the indirect heating operation that does not need fire, the muffle 60 can be uniformly heated and preferably prevent glass from being contaminated.

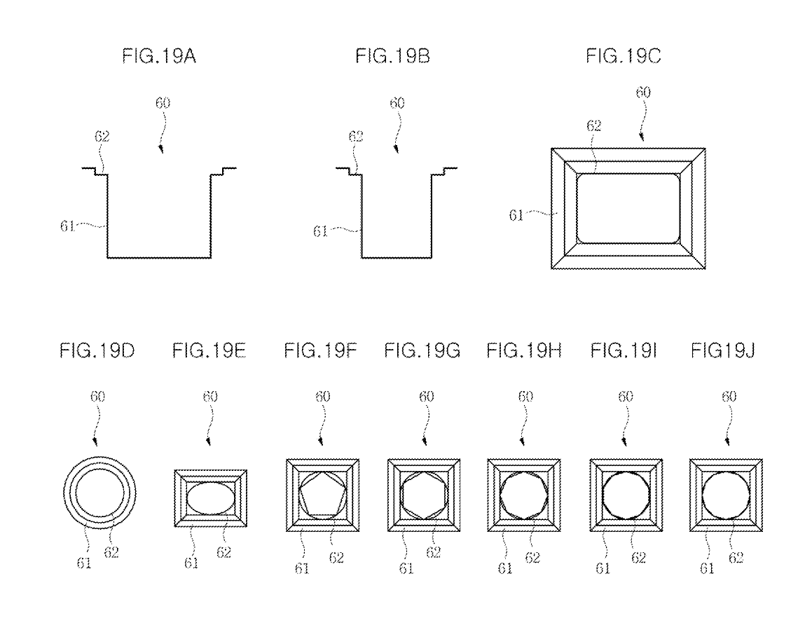

At least one of a body 61 in the shape of a container and an opening 62 in the upper end of the muffle 60 of the present invention is formed in the shape of one selected from a group consisting of a rectangle, a circle, an oval, a pentagon, a hexagon, an octagon, a decagon, and a dodecagon. As illustrated in the front cross-sectional view of FIG. 19A and the side cross-sectional view of FIG. 19B, the muffle 60 is formed of a stainless steel material and has a structure of the body 61 and the opening 62. As illustrated in FIG. 19C, the muffle 60 may select a rectangular structure, like a general fire resistant furnace. However, as illustrated in FIGS. 19D through 19J, the muffle 60 may be realized in the circle, the oval, the pentagon, the hexagon, the octagon, the decagon, the dodecagon, and the like. This is considered that the size or shape of glass may differ according to the type of a finished product and correspondingly change in accordance with an outer shape of glass optimally accommodated in the rack 51. In any cases, only the body 61 may change, only the opening 62 may change, and the body 61 and the opening 62 may change in the same manner.

With regard to the main operation, if a thin plate type glass product that is to be thermally treated and is loaded on the rack 51 is conveyed by using the conveyer 4, the door 5 of the conveying bogie 42 is opened, the elevating motor 52 of the first chamber 47 having no heater operates, and thus the rack 51 elevates. Thereafter, the conveying bogie 42 conveys a process along the rails 41, opens the door 5 of the first chamber 47 having no heater, and the rack 51 is lowered. At the same time, the conveying bogie 42 opens the second chamber 48 having the heater and the main body furnace 20 that are adjacent to each other and elevates the thermally treated rack 51. The same temperature condition is adjusted by the heater 46 before the rack 51 is accommodated in the second chamber 48, and thus the thin plate type glass product does not thermally vary unnecessarily.

According to the above-described construction of the present invention, the apparatus moves from the preheating furnace 10 to the annealing furnace 31 of the cooling furnace 30 by using the second chamber 48 having the heater with a preheating function, and moves from the hot water furnace 32 of the cooling furnace 30 to the cool water furnace 33 by using the first chamber 47 having no heater.

Meanwhile, the moving unit 90 for allowing the preheating furnace 10, the main body furnace 20, and the cooling furnace 30 to move by using a power unit independently from the traveling unit 40 is installed in the lower sides of the preheating furnace 10, the main body furnace 20, and the cooling furnace 30.

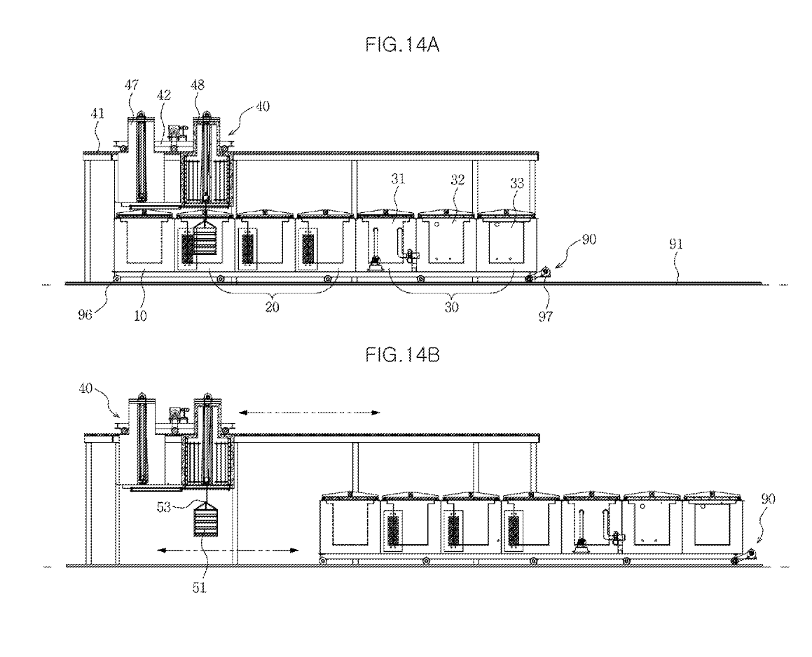

As a first embodiment of the moving unit 90 shown in FIGS. 14A through 16, the moving unit 90 includes a lower rail 91 that is installed on the lower sides of the preheating furnace 10, the main body furnace 20, and the cooling furnace 30 in a direction parallel to a moving direction of the conveying bogie 42, and operates by a driving motor 97 on the lower rail 91.

If the traveling unit 40 and the moving unit 90 move in the same direction, when the conveying bogie 42 moves forward for a subsequent process by the traveling means 40, the preheating furnace 10, the main body furnace 20, and the cooling furnace 30 move backward by the moving unit 90, thereby reducing a moving time between processes.

According to the second embodiment of the moving unit 90 shown in FIGS. 17A and 17B, the moving unit 90 includes a lower rail 92 that is installed on the lower sides of each of the preheating furnace 10, the main body furnace 20, and the cooling furnace 30 in a direction perpendicular to the moving direction of the conveying bogie 42, and operates by a cylinder 99 operating by the driving motor 97 on the lower rail 92.

In this regard, the moving unit 90 may be formed by disposing a driving roller 96 in the lower sides of the preheating furnace 10, the main body furnace 20, and the cooling furnace 30, or may be integrally formed in the lower sides of preheating furnace 10, the main body furnace 20, and the cooling furnace 30.

If the traveling unit 40 and the moving unit 90 move in perpendicular to each other, since the moving unit 90 can be drawn out to the left or right side perpendicular to the moving direction (forward and backward) of the conveying bogie 42 by the traveling unit 40, it is preferably replaced due to a repair or a superannuation when the preheating furnace 10, the main body furnace 20, and the cooling furnace 30 are out of order by the moving unit 90.

In this regard, although not shown, the moving unit 90 may be parallel and perpendicular to the traveling unit 40 by using the two methods of the above two embodiments.

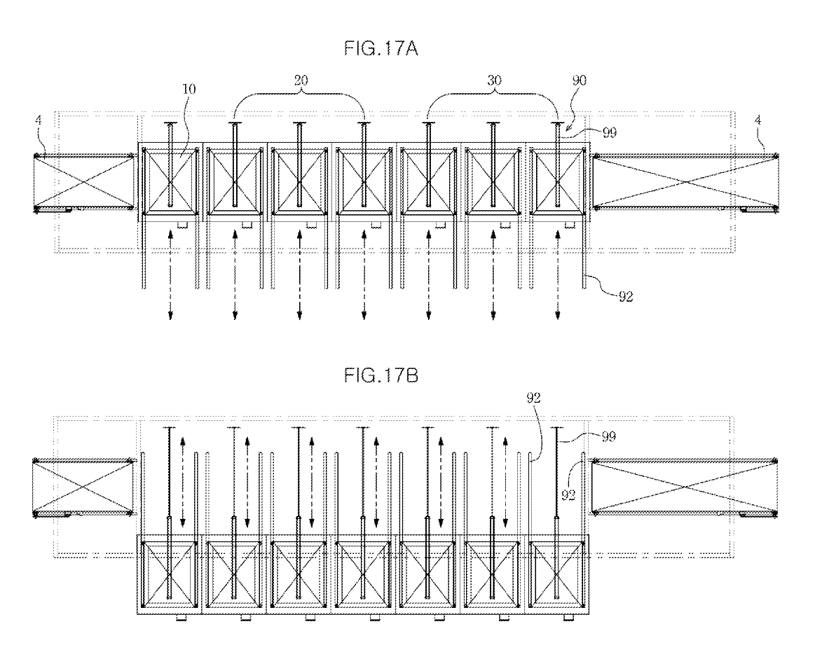

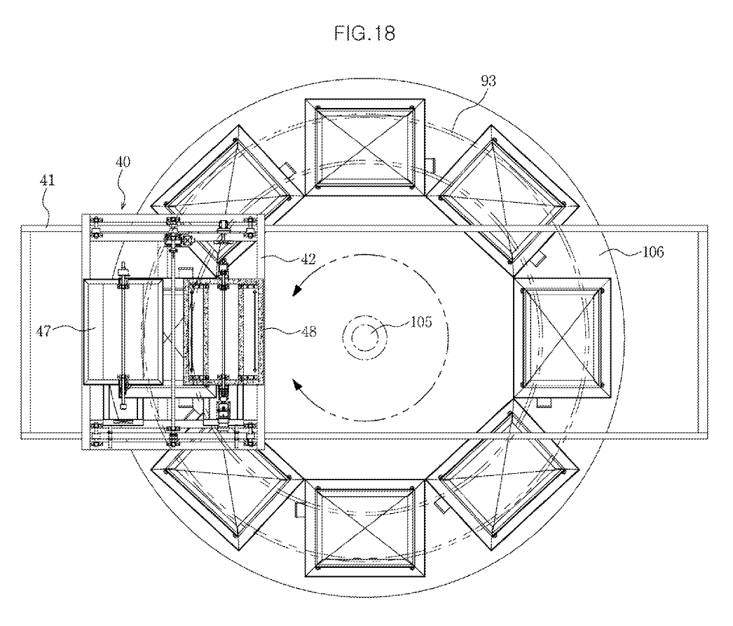

Further, according to the third embodiment of the moving unit 90 shown in FIG. 18, a support plate 106 is installed in the lower sides of the preheating furnace 10, the main body furnace 20, and the cooling furnace 30 to turn the moving direction of the conveying bogie 42 so that the preheating furnace 10, the main body furnace 20, and the cooling furnace 30 are integrally fixed, a rotation shaft 105 that rotatably operates by a motor is installed in the middle thereof in a turn table manner, and moving wheels disposed in the lower portion of the support plate 106 enables a shaft rotation on the lower rail 93.

According to the above construction, a repair and replacement are facilitated as described in the second embodiment, and spaces for installing the preheating furnace 10, the main body furnace 20, and the cooling furnace 30 can be reduced.

The heat treatment apparatus for tempering glass of the present invention can advantageously stabilize quality and increase productivity by inducing a stability and smoothness between processes during automatically performing of a heat treatment operation for the tempered surface of thin plate type glass.

Further, the heat treatment apparatus for tempering glass of the present invention independently drives a conveying unit for moving a conveying bogie disposed on a preheating furnace, a main body furnace, and a cooling furnace and a moving unit disposed in lower portions of the preheating furnace, the main body furnace, and the cooling furnace, thereby reducing a moving time between processes and facilitating repair and replacement jobs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A heat treatment apparatus for tempering thin plate type glass and including a preheating furnace, a main body furnace, and a cooling furnace, the apparatus comprising:
a traveling unit for moving a conveying bogie on a pair of rails installed in parallel on the preheating furnace, the main body furnace, and the cooling furnace;
a rack elevating unit for stably performing an up and down motion of a rack in which the thin plate type glass included in the conveying bogie is accommodated; and
a muffle disposed on the main body furnace and performing an indirect heating operation.

2. The apparatus of claim 1,
wherein the preheating furnace performs ventilation and heating functions, and has a structure of a single fire resistant wall and capable of being opened and closed upward;
the main body furnace performs the indirect heating operation at least one side, and has a structure of a plurality of fire resistant walls and capable of being opened and closed upward; and
the cooling furnace maintains ventilation and cooling, and has a structure of a plurality of fire resistant walls and capable of being opened and closed upward.

3. The apparatus of claim 1, wherein the conveying bogie is installed to move on the pair of rails with a pair of support rollers and a plurality of traveling wheels disposed therebetween, and integrally comprises a first chamber capable of being opened and closed downward and having no heater and a second chamber having a heater.

4. The apparatus of claim 2, wherein the preheating furnace alternately comprises a pipe heater and a far infrared ray heater, and adjusts a temperature by using a ventilator.

5. The apparatus of claim 2, wherein the main body furnace comprises a strip heater in the lower side of the muffle for performing the indirect heating operation.

6. The apparatus of claim 2, wherein the cooling furnace comprises a plurality of ventilators in an annealing furnace, a heat plate heater in a hot water furnace, and a nozzle and a heat plate heater in the cooling furnace

7. The apparatus of claim 1, wherein the traveling unit comprises one or more selected from a group consisting of a ball screw driver, an LM guide driver, a hydraulic and pneumatic driver, a square steel driver, and a chain driver.

8. The apparatus of claim 1, wherein the traveling unit comprises a ball screw driver for fastening a nut on spiral shafts installed in parallel to both sides thereof and conveying the nut and the conveying bogie by rotations of the spiral shafts by connecting the conveying bogie to the nut, and a square steel driver for allowing the traveling wheels of the conveying bogie to stably arrive in a rail having a C-shaped cross section and conveying the conveying bogie by winding or unwinding a wire connected to the front and rear of the conveying bogie.

9. The apparatus of claim 1, wherein the rack elevating unit comprises one or more selected from a group consisting of the ball screwdriver, the LM guide driver, the hydraulic and pneumatic driver, and the chain driver.

10. The apparatus of claim 1, wherein the rack elevating unit comprises the ball screwdriver for vertically installing the spiral shafts, installing the nut on the spiral shafts, and stably conveying the rack connected to the nut by the rotations of the spiral shafts up and down.

11. The apparatus of claim 1, wherein the muffle comprises a body in the shape of a container and an opening in the upper end thereof, wherein at least one of the body and the opening is formed in the shape of one selected from a group consisting of a rectangle, a circle, an oval, a pentagon, a hexagon, an octagon, a decagon, and a dodecagon, and is correspondingly formed in accordance with an outer shape of the rack in which the thin plate type glass is optimally accommodated.

12. The apparatus of claim 1, further comprising: a moving unit installed in the lower sides of the preheating furnace, the main body furnace, and the cooling furnace and for independently operating the preheating furnace, the main body furnace, and the cooling furnace by a motor device.

13. The apparatus of claim 12, wherein the moving unit comprises a lower rail installed on the bottom in parallel to a moving direction of the conveying bogie, and a driving roller installed in each of the lower side of the preheating furnace, the main body furnace, and the cooling furnace and for operating by the motor device.

14. The apparatus of claim 12, wherein the moving unit comprises a lower rail installed on the bottom in perpendicular to the moving direction of the conveying bogie, and the driving roller installed in each of the lower side of the preheating furnace, the main body furnace, and the cooling furnace and for operating by the motor device.

15. The apparatus of claim 12, wherein the moving unit comprises a lower rail in the shape of a circle installed on the bottom to turn in the moving direction of the conveying bogie, and the driving roller installed in each of the lower side of the preheating furnace, the main body furnace, and the cooling furnace and for operating by the motor device.
